(19) United States
(12) Patent Application Publication
(10) Pub. No.: US 2026/0142239 A1
(43) Pub. Date: May 21, 2026

(54) ELECTRODE MEMBER

(71) Applicant: TOYOTA JIDOSHA KABUSHIKI KAISHA, Toyota-shi (JP)

(72) Inventors: Mitsuru TATEISHI, Toyota-shi (JP); Masashi Ueda, Toyota-shi (JP); Jun Izumi, Toyota-shi (JP); Shizuka Masuoka, Nagoya-shi (JP); Aya Sato, Nagoya-shi (JP); Tatsuya Yamamoto, Toyohashi-shi (JP); Yuji Katayama, Okazaki-shi (JP); Keitaro Machida, Hamamatsu-shi (JP)

(73) Assignee: TOYOTA JIDOSHA KABUSHIKI KAISHA, Toyota-shi (JP)

(21) Appl. No.: 19/381,136

(22) Filed: Nov. 6, 2025

(30) Foreign Application Priority Data
Nov. 20, 2024 (JP) 2024-202197

(51) Int. Cl. H01M 10/0587; H01M 50/103; H01M 50/121

(52) U.S. Cl. CPC H01M 10/0587; H01M 50/103; H01M 50/121

(57) ABSTRACT

An electrode member includes a substrate that includes a resin substrate and an electroconductive layer that is disposed on the resin substrate, and an active material layer that is disposed on the electroconductive layer, in which the resin substrate includes a recessed portion that is recessed inward in a thickness direction that is parallel to a laminating direction of the substrate and the active material layer, at a position at which the resin substrate is overlaid by the active material layer in the laminating direction.

### CROSS-REFERENCE TO RELATED APPLICATION

This application claims priority to Japanese Patent Application No. 2024-202197 filed on Nov. 20, 2024. The disclosure of the above-identified application, including the specification, drawings, and claims, is incorporated by reference herein in its entirety.

### BACKGROUND

### 1. Technical Field

The present disclosure relates to an electrode member.

### 2. Description of Related Art

A conventional electrode assembly with the following structure is disclosed in Japanese Unexamined Patent Application Publication No. 2019-096592 (JP 2019-096592 A). In the structure, an electrode member having an electroconductive layer, and an active material layer, which are laminated in this order on the surface of an insulating substrate, is used for at least one of a sheet-like cathode member and a sheet-like anode member, a separator is disposed between the cathode member and the anode member, and these are wound together. The electroconductive layer includes a first portion that is coated with the active material layer and a second portion that protrudes from the first portion, and a through hole that passes through in a thickness direction is provided in the second portion and in a portion of the insulating substrate corresponding to the second portion.

### SUMMARY

A manufacturing process of an electrode member includes a pressing step in which an active material layer and a substrate are nipped between rollers and pressed such that the active material layer that is applied onto the substrate is fixed thereupon. The substrate has an uncoated region in which no active material layer is applied, and in the pressing step, the roller comes into contact with the active material layer but does not come into contact with the uncoated region. Accordingly, the coated region of the substrate, in which the active material layer is applied, stretches when pressed, but the uncoated region thereof does not readily stretch, which can result in a difference in stretching between the coated region and the uncoated region. When a substrate containing a resin member is used, there is a concern that the uncoated region may become curved or the uncoated region may become wrinkled, due to the above-described difference in elongation.

The present disclosure has been made in consideration of the foregoing problems, and an object of the present disclosure is to provide an electrode member that can suppress wrinkling and curving in uncoated regions in which no active material layer is applied.

An electrode member according to the present disclosure includes
a substrate that includes a resin substrate and an electroconductive layer that is disposed on the resin substrate, and
an active material layer that is disposed on the electroconductive layer.

The resin substrate includes a recessed portion that is recessed inward in a thickness direction that is parallel to a laminating direction of the substrate and the active material layer, at a position at which the resin substrate is overlaid by the active material layer in the laminating direction.

According to the above configuration, the recessed portion is formed in the resin substrate in a region in which the active material layer is formed and which readily stretches, and thus the resin substrate is thin and the electroconductive layer is thick. This enables stressing to be suppressed in regions that readily stretch when the electrode member is pressed after the active material layer is applied, and enables difference in stretching between these regions and regions in which no active material layer is formed and do not readily stretch to be suppressed. As a result, wrinkling and curving deformation can be suppressed in the regions in which no active material layer is formed and do not readily stretch.

In the electrode member according to the present disclosure, the recessed portion may be provided such that a depth of the recessed portion increases further toward an inward side in a width direction that is orthogonal to the laminating direction.

According to the above configuration, the recessed portion becomes gradually deeper toward the middle in the width direction, such that when the electrode member is pressed after the active material layer is applied, the change in stretching in the width direction can be subdued.

In the electrode member according to the present disclosure, both end portions of the active material layer may be located in the inward side from both end portions of the recessed portion in the width direction that is orthogonal to the laminating direction.

According to the above configuration, the active material layer does not protrude beyond the position of the recessed portion in the width direction. This enables stretching to be suppressed more reliably in regions that readily stretch when the electrode member is pressed after the active material layer is applied, and enables difference in stretching between these regions and regions in which no active material layer is formed and do not readily stretch to be suppressed.

According to the present disclosure, an electrode member can be provided that can suppress wrinkling and curving in uncoated regions where no active material layer is applied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery according to a first embodiment;

FIG. 2 is a disassembled perspective view of the battery according to the first embodiment;

FIG. 3 is a sectional view of the battery in FIG. 1, taken along line III-III, as viewed in a direction along the arrows;

FIG. 4 is a cross-sectional view of an electrode assembly in FIG. 3, taken along line IV-IV, as viewed in a direction along the arrows;

FIG. 5 is a sectional view of a first electrode member according to the first embodiment; and

FIG. 6 is a sectional view of a first electrode member according to a second embodiment.

### DETAILED DESCRIPTION OF EMBODIMENTS

Hereinafter, embodiments of the present disclosure will be described in detail with reference to the drawings. In the following embodiments, portions that are the same, or are in common, are denoted by the same signs throughout the drawings, and description thereof will not be repeated.

### First Embodiment

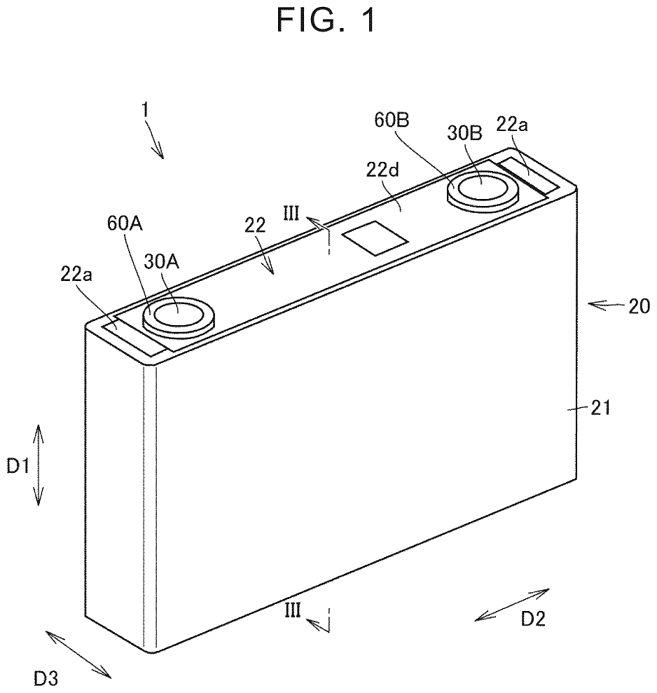

FIG. 1 is a perspective view of a battery according to a first embodiment. As illustrated in FIG. 1, a battery 1 according to the first embodiment is a so-called prismatic battery. The battery 1 may be a secondary battery that is configured to be capable of being charged and discharged, such as a lithium-ion battery, a nickel metal hydride battery, or the like. The battery 1 can be used as a cell that is included in a power storage module that is installed in an electrified vehicle, for example.

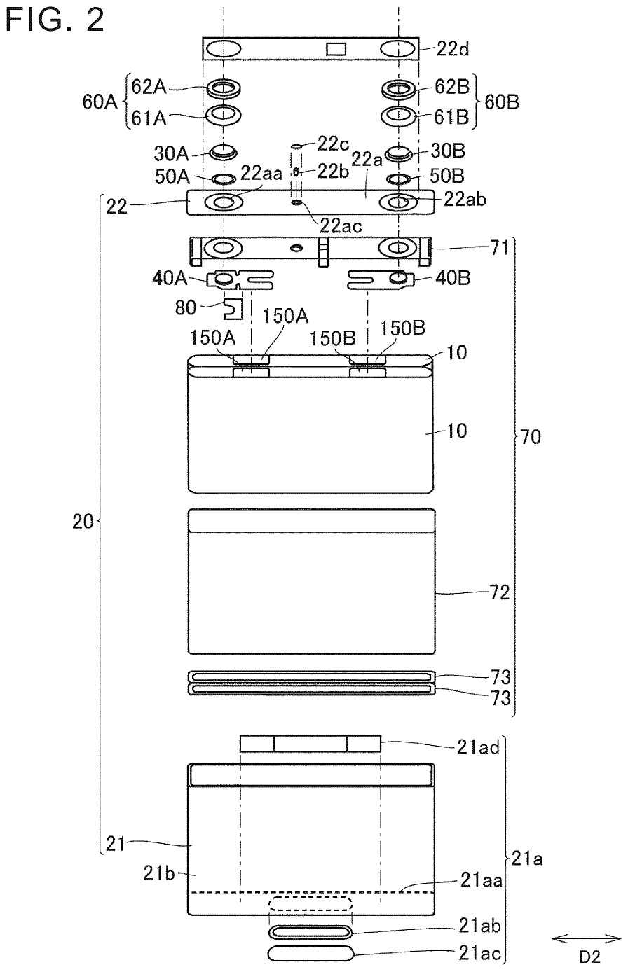

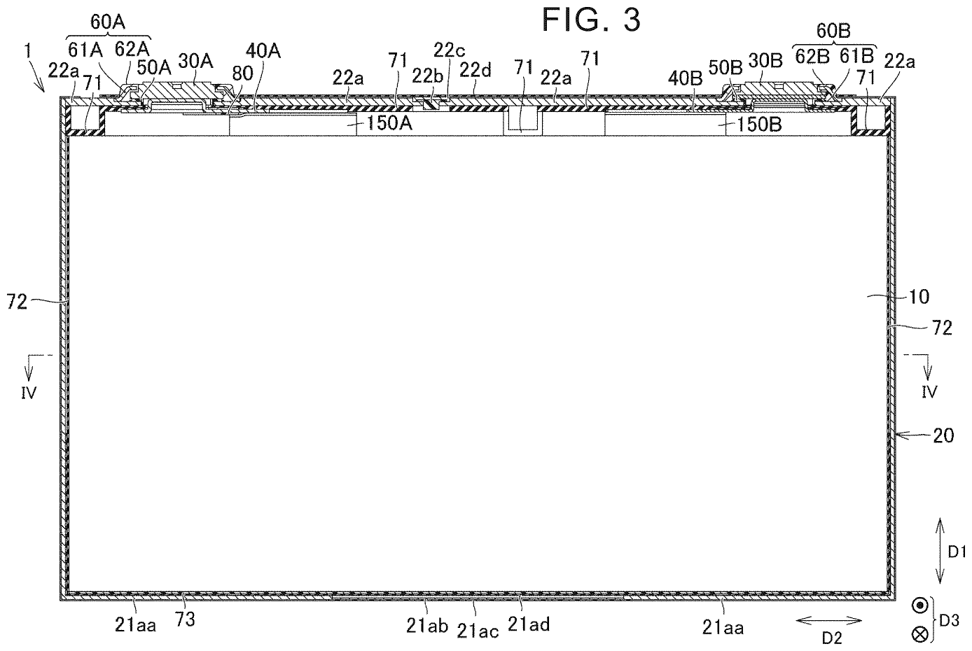

FIG. 2 is a disassembled perspective view of the battery according to the first embodiment. FIG. 3 is a sectional view of the battery in FIG. 1, taken along line III-III, as viewed in a direction along the arrows. As illustrated in FIGS. 1 to 3, the battery 1 according to the first embodiment includes an electrode assembly 10, a case 20, a first external terminal 30A, a second external terminal 30B, a first connecting member 40A, and a second connecting member 40B. Also, the battery 1 according to the first embodiment includes a first seal ring 50A, a second seal ring 50B, a first terminal supporting portion 60A, a second terminal supporting portion 60B, an insulating member 70, and a fuse protecting portion 80.

The case 20 has electroconductivity. An electroconductive portion of the case 20 is made of a metal such as aluminum or the like, for example. The case 20 houses the electrode assembly 10. The case 20 also houses an electrolytic solution that is omitted from illustration.

The case 20 includes a case body 21 and a lid 22. The case body 21 includes a bottom wall 21a, and a peripheral wall 21b that is erected upright from the bottom wall 21a.

The bottom wall 21a includes a bottom body 21aa, a pressure relief valve 21ab, an outer-side protecting film 21ac, and an inner-side protecting film 21ad. The peripheral wall 21b is erected upright from the bottom body 21aa. The pressure relief valve 21ab is provided in the bottom body 21aa. The outer-side protecting film 21ac covers the pressure relief valve 21ab from the outside. The inner-side protecting film covers the pressure relief valve 21ab from the inside. The bottom body 21aa and the pressure relief valve 21ab are made of a metal such as aluminum or the like.

An opening is formed at an upper end of the peripheral wall 21b. The peripheral wall 21b has a substantially rectangular outer shape as viewed from an opening direction of the opening (normal direction of a plane of the opening). The opening and the bottom wall 21a are arrayed in a first direction D1. The first direction D1 may be a height direction or an up-down direction of the battery 1. The peripheral wall 21b is made of a metal such as aluminum or the like.

The lid 22 includes a lid body 22a, a sealing plug 22b, a plug cover 22c, and an insulating cover 22d.

The lid body 22a is joined to the peripheral wall 21b by welding or the like, so as to close off the opening of the peripheral wall 21b. The lid body 22a has formed therein a first connecting hole 22aa, a second connecting hole 22ab, and a liquid injection hole 22ac. The liquid injection hole 22ac is a through hole for injecting an electrolytic solution into the case body 21 in a manufacturing process of the battery 1.

The sealing plug 22b seals off the liquid injection hole 22ac. The plug cover 22c covers the liquid injection hole 22ac and the sealing plug 22b. The insulating cover 22d covers the liquid injection hole 22ac, the sealing plug 22b, and the plug cover 22c.

The first external terminal 30A and the second external terminal 30B are provided in the battery 1 so as to be externally exposed. The first connecting member 40A and the second connecting member 40B are electroconductive. At least a portion of the first connecting member 40A and at least a portion of the second connecting member 40B are disposed inside the case 20.

The first external terminal 30A or the first connecting member 40A is inserted through the first connecting hole 22aa. The first external terminal 30A and the first connecting member 40A are joined together. The first connecting member 40A is joined to the electrode assembly 10. Accordingly, the first external terminal 30A is electrically connected to the electrode assembly 10.

The second external terminal 30B or the second connecting member 40B is inserted through the second connecting hole 22ab. The second external terminal 30B and the second connecting member 40B are joined together. The second connecting member 40B is joined to the electrode assembly 10. Accordingly, the second external terminal 30B is electrically connected to the electrode assembly 10.

Note that in the present embodiment, the first external terminal 30A is a cathode terminal, and the second external terminal 30B is an anode terminal. The first external terminal 30A and the second external terminal 30B are arrayed in a second direction D2. The second direction D2 is a direction that is orthogonal to the first direction D1.

The first seal ring 50A is provided along the first connecting hole 22aa. The first seal ring 50A is provided in a gap between the lid body 22a and the first external terminal 30A, so as to seal off this gap. The second seal ring 50B is provided along the second connecting hole 22ab. The second seal ring 50B is provided in a gap between the lid body 22a and the second external terminal 30B, so as to seal off this gap. The first seal ring 50A and the second seal ring 50B have electrical insulation properties.

The first terminal supporting portion 60A is retained to the lid body 22a. The first terminal supporting portion 60A supports the first external terminal 30A from an outer peripheral side of the first external terminal 30A. The first terminal supporting portion 60A includes a first retaining ring 61A and a first covering ring 62A. The first retaining ring 61A extends annularly so as to surround the first connecting hole 22aa, and is directly retained on the lid body 22a. The first covering ring 62A covers the first retaining ring 61A. The first retaining ring 61A supports the first external terminal 30A via the first covering ring 62A. The first covering ring 62A is a resin member that has electrical insulation properties or that is relatively weakly electroconductive.

The second terminal supporting portion 60B is retained to the lid body 22a. The second terminal supporting portion 60B supports the second external terminal 30B from an outer peripheral side of the second external terminal 30B. The second terminal supporting portion 60B includes a second retaining ring 61B and a second covering ring 62B. The second retaining ring 61B extends annularly so as to surround the second connecting hole 22ab, and is directly retained to the lid body 22a. The second covering ring 62B covers the second retaining ring 61B. The second retaining ring 61B supports the second external terminal 30B via the second covering ring 62B. The second covering ring 62B is a resin member that has electrical insulation properties.

The insulating member 70 is electrically insulating. The insulating member 70 is disposed between a plurality of the electrode assemblies 10 and the case 20. The insulating member 70 electrically insulates the electrode assemblies 10 and the case 20 from each other. The insulating member 70 includes an insulating bracket 71, a peripheral face insulating portion 72, and a bottom face insulating portion 73.

The insulating bracket 71 is disposed between the electrode assemblies 10 and the lid body 22a. The insulating bracket 71 has relatively high rigidity and is in contact with both the electrode assemblies 10 and the lid body 22a. The electrode assemblies 10 are thus fixed in the case 20 in the first direction D1.

The peripheral face insulating portion 72 is disposed between the electrode assemblies 10 and the peripheral wall 21b. The peripheral face insulating portion 72 is a member in the form of a film.

The bottom face insulating portion 73 is disposed between each of the electrode assemblies 10 and the bottom wall 21a. The bottom face insulating portion 73 is a member in the form of a film. In the present embodiment, the bottom face insulating portion 73 is bonded to the electrode assemblies 10. The bottom face insulating portion 73 also covers just part of bottom faces of the electrode assemblies 10. Note that the bottom face insulating portion 73 may cover the entire bottom face.

As illustrated in FIG. 2, the battery 1 according to the present embodiment includes multiple electrode assemblies 10. The battery 1 typically includes two electrode assemblies 10. These electrode assemblies 10 are arrayed in a third direction D3. The third direction D3 is a direction orthogonal to both the first direction D1 and the second direction D2. Note that the peripheral face insulating portion 72 may integrally cover the electrode assemblies 10 such that these electrode assemblies 10 are fixed together.

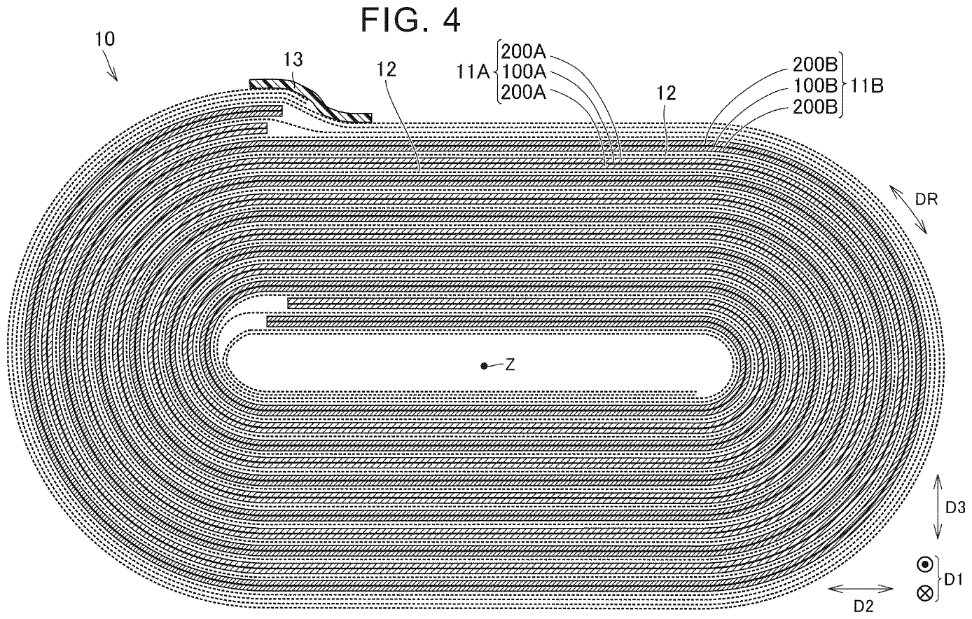

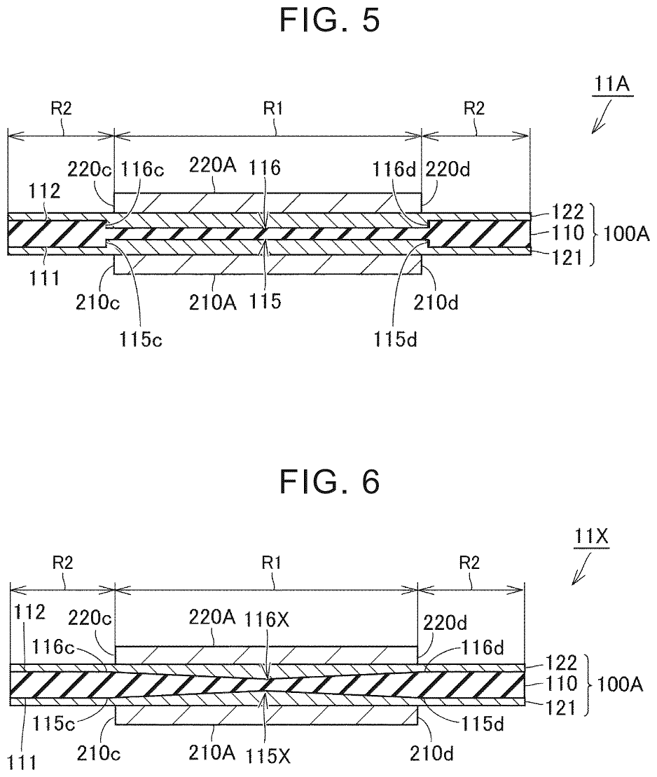

The electrode assembly 10 is provided with a plurality of first tabs 150A and a plurality of second tabs 150B. One end side of the first tabs 150A is connected to a first electroconductive layer 121 (see FIG. 5) and a second electroconductive layer 122 (see FIG. 5) of a first electrode member 11A (see FIG. 4), which will be described later. The other end side of the first tabs 150A is joined to the aforementioned first connecting member 40A by ultrasonic welding, or the like.

One end side of the second tabs 150B is connected to a second substrate 100B of a second electrode member 11B (see FIG. 4), which will be described later. The other end side of the second tabs 150B is joined to the second connecting member 40B by ultrasonic welding, or the like.

FIG. 4 is a cross-sectional view of the electrode assembly in FIG. 3, taken along line IV-IV, as viewed in a direction along the arrows. The electrode assembly 10 includes the first electrode member 11A, the second electrode member 11B, separators 12, and a tape member 13. In the electrode assembly 10, the first electrode member 11A, the second electrode member 11B, and the separators 12 are wound encompassing about a winding axis Z. In the present embodiment, a case in which the electrode assembly 10 is a wound electrode assembly will be described as an example, but is not limited to this. The electrode assembly 10 may be a laminated electrode assembly in which the first electrode member 11A, the second electrode member 11B, and the separators 12 are laminated in one direction (e.g., third direction D3). Note that in FIG. 4, the separators 12 are schematically represented by dashed lines.

Outer shapes of first electrode member 11A and the second electrode member 11B are like sheets. The electrode assembly 10 is made by winding the first electrode member 11A and the second electrode member 11B with one or more separators 12 interposed therebetween. The first electrode member 11A is, for example, a cathode, and the second electrode member 11B is an anode.

The first electrode member 11A includes a first substrate 100A and a first active material layer 200A. The first active material layer 200A has the same polarity as the first electrode member 11A. The first active material layer 200A is, for example, a cathode active material layer. A known material can be used as the cathode active material layer.

The first active material layer 200A is provided on front and rear faces of the first substrate 100A. A detailed structure of the first substrate 100A will be described later with reference to FIG. 5.

The second electrode member 11B includes the second substrate 100B and a second active material layer 200B. The second active material layer 200B has the same polarity as the second electrode member 11B. The second electrode member 11B is, for example, an anode active material layer. A known material can be used as the anode active material layer.

The second substrate 100B is made of a metal member containing copper, such as copper foil or the like, for example. The second active material layer 200B is provided on front and rear faces of the second substrate 100B.

The separator 12 is provided between the first electrode member 11A and the second electrode member 11B. The separator 12 separates the first electrode member 11A from the second electrode member 11B while allowing ions to travel between the first electrode member 11A and the second electrode member 11B. The ions are, for example, lithium ions. The separator 12 has electrical insulation properties.

In the electrode assembly 10, the separator 12 is located on the most inner peripheral side thereof. Also, in the electrode assembly 10, the separator 12 is located on the most outer peripheral side thereof. An edge of the separator 12 on an outer peripheral side in a winding direction DR is fixed by the tape member 13 that is disposed on an outer peripheral face of the separator 12.

The separator 12 may contain, for example, polyolefin resin or the like. The separator 12 may be essentially made of polyolefin resin, for example. The polyolefin resin may include, for example, at least one that is selected from a group consisting of polyethylene (PE) and polypropylene (PP).

FIG. 5 is a sectional view of the first electrode member according to the first embodiment. Specifically, FIG. 5 is a sectional view of the first electrode member 11A taken along a plane perpendicular to the second direction.

As illustrated in FIG. 5, the first substrate 100A of the first electrode member 11A has a coated region R1 that is coated by the first active material layer 200A, and uncoated regions R2 that are not coated by the first active material layer 200A. In the first electrode member 11A, the first substrate 100A includes a first resin substrate 110, and the first electroconductive layer 121 and the second electroconductive layer 122 that are laminated on the first resin substrate 110.

The first resin substrate 110 has a first face 111 and a second face 112 in a thickness direction. Note that the thickness direction is parallel to a laminating direction in which the first substrate 100A and the first active material layer 200A are laminated.

The first resin substrate 110 has recessed portions 115 and 116 that are recessed inward in the thickness direction, at least at positions that are overlaid by the first active material layer 200A in the laminating direction. The recessed portion 115 is provided on the first face 111 side. The recessed portion 116 is provided on the second face 112 side. The recessed portions 115 and 116 are substantially U-shaped. Bottom faces of the recessed portions 115 and 116 are flat in a direction orthogonal to the thickness direction.

In a width direction of the first resin substrate 110, which is orthogonal to the thickness direction (above laminating direction), the width of the recessed portions 115 and 116 is greater than the width of the first active material layer 200A. Note that the width direction of the electrode assembly 10 is parallel to the first direction. The recessed portion 115 has both end portions 115c and 115d in the width direction. The recessed portion 116 has both end portions 116c and 116d in the width direction.

The first resin substrate 110 may be made of a material having higher rigidity than the separators 12. The first resin substrate 110 is made of a resin composition containing, for example, a polyamide-based resin, a polyester-based resin, or a polyolefin-based resin.

The first electroconductive layer 121 is formed on the first face 111. More specifically, the first electroconductive layer 121 is formed in the recessed portion 115, and on the first face 111 on both outward sides of the recessed portion 115 in the width direction. A face of the first electroconductive layer 121 opposite to the side on which the first resin substrate 110 is located is provided so as to be substantially flat. The first electroconductive layer 121 that is formed in the recessed portion 115 is thicker than the first electroconductive layer 121 that is formed on the first face 111 on both outward sides of the recessed portion 115.

The second electroconductive layer 122 is formed on the second face 112. More specifically, the second electroconductive layer 122 is formed in the recessed portion 116, and on the second face 112 on both outward sides of the recessed portion 116 in the width direction. A face of the second electroconductive layer 122 opposite to the side on which the first resin substrate 110 is located is provided so as to be substantially flat. The second electroconductive layer 122 that is formed in the recessed portion 116 is thicker than the second electroconductive layer 122 that is formed on the second face 112 on both outward sides of the recessed portion 116.

The first electroconductive layer 121 and the second electroconductive layer 122 are made of a metal material containing aluminum. The first electroconductive layer 121 and the second electroconductive layer 122 may be formed on the first face 111 and the second face 112 by vapor deposition or the like. Also, the first electroconductive layer 121 and the second electroconductive layer 122 may be made of metal foil and be bonded onto the first face 111 and the second face 112 by an adhesive.

The first active material layer 200A is formed on the first electroconductive layer 121 and the second electroconductive layer 122. Specifically, first active material layer 200A is formed on first electroconductive layer 121 and the second electroconductive layer 122 at positions overlaying the recessed portions 115 and 116 in the stacking direction.

The first active material layer 200A has a first portion 210A and a second portion 220A. The first portion 210A is formed on the first electroconductive layer 121. The second portion 220A is formed on the second electroconductive layer 122. The first portion 210A has both end portions 210c and 210d in the width direction, and the second portion 220A has both end portions 220c and 220d in the width direction.

Both end portions of the first active material layer 200A are located further on the inward side from both end portions of the recessed portions 115 and 116 in the width direction. Specifically, both end portions 210c, 210d of the first portion 210A are located further on the inward side from both end portions 115c and 115d of the recessed portion 115 in the width direction. Both end portions 220c, 220d of the second portion 220A are located further on the inward side from both end portions 116c and 116d of the recessed portion 116 in the width direction.

In general, when fixing an active material layer onto a substrate on which it has been applied, the active material layer and the substrate are nipped between a pair of rollers and pressed. During this pressing, the substrate readily stretches at the positions that are overlaid with the active material layer, but does not readily stretch at uncoated regions at which no active material layer is formed.

Here, in the first electrode member 11A according to the first embodiment, the first resin substrate 110 has recessed portions 115 and 116 that are recessed in the thickness direction, which is parallel to the stacking direction, at positions overlaying the first active material layer 200A in the stacking direction.

Accordingly, in the region that is overlaid by the first active material layer 200A in the stacking direction, the first resin substrate 110 is thinner, and first electroconductive layer 121 and second electroconductive layer 122 are thicker. This enables stretching to be suppressed in the regions that readily stretch when the first electrode member 11A is pressed after the first active material layer 200A is applied, in the manufacturing process of the first electrode member 11A. Thus, the difference in stretching with respect to the region in which the first active material layer 200A is not formed and which does not readily stretch can be suppressed. As a result, wrinkling or curving deformation can be suppressed in the region that does not readily stretch, in which the first active material layer 200A is not formed.

Also, both end portions of the first active material layer 200A are located further on the inward side from both end portions of the recessed portions 115 and 116 in the width direction. This enables first active material layer 200A to be suppressed from protruding from the recessed portions 115 and 116 in the width direction. Thus, stretching can be more reliably suppressed in regions that readily stretch when the first electrode member 11A is pressed after the first active material layer 200A is applied, as well as suppressing the difference in stretching between these regions and regions that stretch less readily in which the first active material layer 200A is not formed.

### Second Embodiment

FIG. 6 is a sectional view of a first electrode member according to a second embodiment. A first electrode member 11X according to the second embodiment will be described with reference to FIG. 6.

As illustrated in FIG. 6, the first electrode member 11X according to the second embodiment differs from the first electrode member 11 according to the first embodiment with respect to shapes of recessed portions 115X and 116X. Other configurations are substantially the same.

The recessed portions 115X and 116X are provided such that the depths thereof increase the further toward the inward side in the width direction that is orthogonal to the stacking direction. The recessed portions 115X and 116X are substantially V-shaped. Accordingly, in the coated region R1, the first resin substrate 110 gradually becomes thinner toward valley bottoms of the recessed portions 115X and 116X.

The first electrode member 11X according to the second embodiment that is configured in this way can also yield substantially the same effects as the first electrode member 11A according to the first embodiment. Also, by providing the recessed portions 115X and 116X such as described above, when the first electrode member 11A is pressed after the first active material layer 200A is applied, the change in stretching of the first resin substrate 110 in the width direction can be made to be more subdued in the coated region R1. Other Modifications

In the above first and second embodiments, an example has been described in which the first substrate 100A in the first electrode member 11A, which is a cathode, includes the first resin substrate 110, the first electroconductive layer 121, and the second electroconductive layer 122, but this is not limited to this. In the second electrode member 11B, which is an anode, the second substrate 100B may also be configured in substantially the same way as that of the first substrate 100A. That is to say, the second substrate 100B may include a second resin substrate and an electroconductive layer that is formed on the second resin substrate. In this case, the electroconductive layer is made of a metal containing copper. Furthermore, the second resin substrate may have a recessed portion (second recessed portion) that is recessed inward in the thickness direction at a position that is overlaid by the active material layer in the laminating direction, in which the second resin substrate and the electroconductive layer are laminated.

In the first and second embodiments described above, a case in which the first electrode member 11A is a cathode and the second electrode member 11B is an anode has been exemplified, but is not limited to this. The first electrode member 11A may be an anode, and the second electrode member 11B may be a cathode. In this case, each of the members making up the first electrode member 11A and the second electrode member 11B is selected as appropriate with respect to the polarity of the relevant substrate.

The embodiments that are disclosed herein are exemplary in all respects and are not restrictive. The scope of the present disclosure is set forth in the claims, and includes all modifications that fall within the meaning and scope equivalent to the claims.

What is claimed is:

1. An electrode member, comprising:
a substrate that includes a resin substrate and an electroconductive layer that is disposed on the resin substrate; and
an active material layer that is disposed on the electroconductive layer, wherein the resin substrate includes a recessed portion that is recessed inward in a thickness direction that is parallel to a laminating direction of the substrate and the active material layer, at a position at which the resin substrate is overlaid by the active material layer in the laminating direction.

2. The electrode member according to claim 1, wherein the recessed portion is provided such that a depth of the recessed portion increases further toward an inward side in a width direction that is orthogonal to the laminating direction.

3. The electrode member according to claim 1, wherein both end portions of the active material layer are located in the inward side from both end portions of the recessed portion in the width direction that is orthogonal to the laminating direction.
